(19) United States
(12) Patent Application Publication
(10) Pub. No.: US 2017/0344636 A1
(43) Pub. Date: Nov. 30, 2017

(54) DETERMINING WEB-PAGE KEYWORD RELEVANCE BASED ON SOCIAL MEDIA

(71) Applicant: International Business Machines Corporation, Armonk, NY (US)

(72) Inventors: Emmanuel Barajas Gonzalez, Guadalajara (MX); Lorena Gonzalez Saldana, Zapopan (MX); Shaun E. Harrington, Sahuarita, AZ (US); Juan Pablo Marin Rosas, Tonala (MX)

(73) Assignee: International Business Machines Corporation, Armonk, NY (US)

(21) Appl. No.: 15/168,347

(22) Filed: May 31, 2016

(51) Int. Cl. G06F 17/30

(52) U.S. Cl. CPC G06F 17/30864

(57) ABSTRACT

A method for determining keyword relevance based on social media includes receiving initial keywords associated with a particular web page. The method queries one or more social media platforms using the initial keywords. The results of the queries are then analyzed and new keywords are generated based on the results. An author relevance factor is determined for each author associated with the results, and numerical statistics are generated for occurrences of each new keyword in the results. A ranking is then determined for each new keyword based on the author relevance factors and numerical statistics. The new keywords and associated rankings may then be provided to a user for decision making purposes. A corresponding system and computer program product are also disclosed herein.

### BACKGROUND

### Field of the Invention

This invention relates to systems and methods for determining relevance of web-page keywords based on results returned by social media.

### Background of the Invention

The Internet provides access to billions of web pages that are organized in the form of websites, portals, and platforms that cover a wide variety of topics. To enable users to find these sites, various companies have developed technology to crawl the billions of interconnected documents that make up the world wide web. This information is then used to form indexes that document the information that was discovered. These indexes may be used by search engines. When a user performs a query using a search engine, the user is presented with links to web pages recorded in the indexes. In providing such links, the search engine may need to sift through millions of pages recorded in the indexes to find matches to the query.

A key element of a web page is the content used by search engine to generate its indexes. This content includes a web page's keywords. These keywords may be located or used in a web page's title, Uniform Resource Locator (URL), body text, image names, meta tags, and/or the like. Having a good set of keywords is vital to ensuring that a web page will appear in the search results related to a certain topic. This will ideally generate more visits to the web page and potentially more business opportunities. Maintaining a good set of relevant keywords can be a daunting and time-consuming task since the information on a website or web page may be constantly evolving. Concepts that are presented in many websites may change or become obsolete at a rapid rate. For example, the website of a news provider may contain news stories that change on an hourly, daily, or weekly basis. Similarly the website of an online retailer may market products that are constantly changing.

In view of the foregoing, what are needed are systems and methods to ensure that a web page has a good set of keywords to optimize results from search engines. Ideally, such systems and methods will frequently update keywords to keep pace with changes in a web page's content, and to keep pace with comments and ideas that are posted in social networks about topics mentioned in the web page.

### SUMMARY

Systems and methods have been developed to determine the relevance of keywords based on results returned by social media. The features and advantages of the invention will become more fully apparent from the following description and appended claims, or may be learned by practice of the invention as set forth hereinafter.

Consistent with the foregoing, a method for determining keyword relevance based on social media is disclosed. In one embodiment, such a method includes receiving initial keywords associated with a particular web page. The method queries one or more social media platforms using the initial keywords. The results of the queries are then analyzed and new keywords are generated based on the results. An author relevance factor is determined for each author associated with the results, and numerical statistics are generated for occurrences of each new keyword in the results. A ranking is then determined for each new keyword based on the author relevance factors and numerical statistics. The new keywords and associated rankings may then be provided to a user for decision making purposes.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computing system in which a system and method in accordance with the invention may be implemented;

FIG. 2 is a flow diagram showing one example of how a search engine works;

FIG. 3 is a flow diagram showing how a keyword generator in accordance with the invention may be used to determine more effective keywords for a web page;

FIG. 4 is a high-level block diagram showing various sub-modules within the keyword generator;

FIG. 5 is a flow diagram showing how the keyword generator may generate a new set of keywords from an initial set of keywords; and

FIG. 6 shows several formulas that may be used to determine author relevance and keyword ranking.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

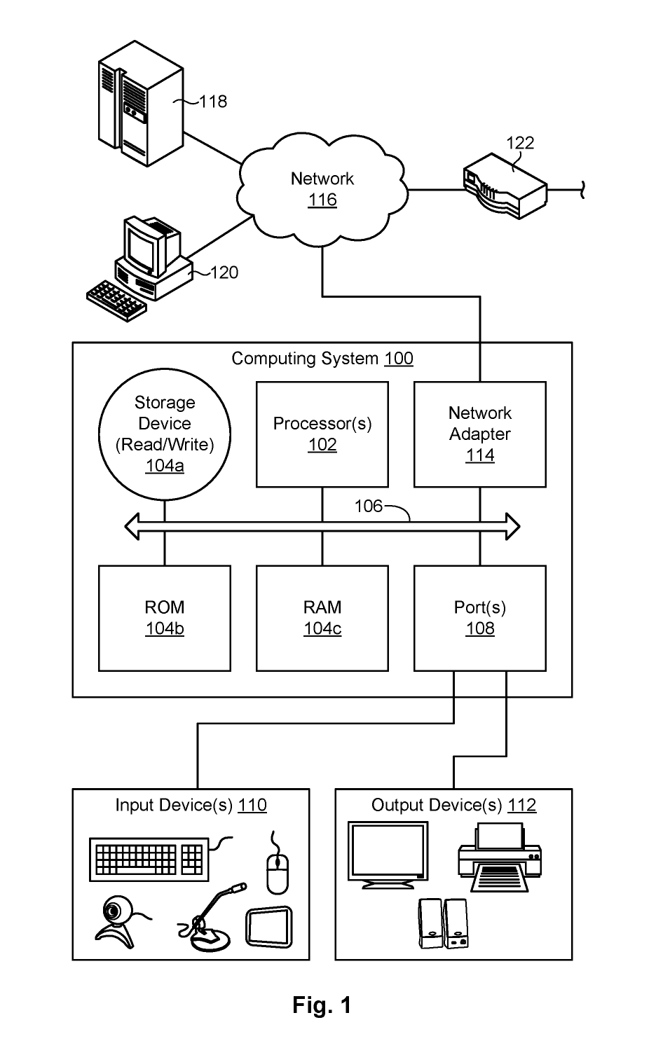

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented only by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

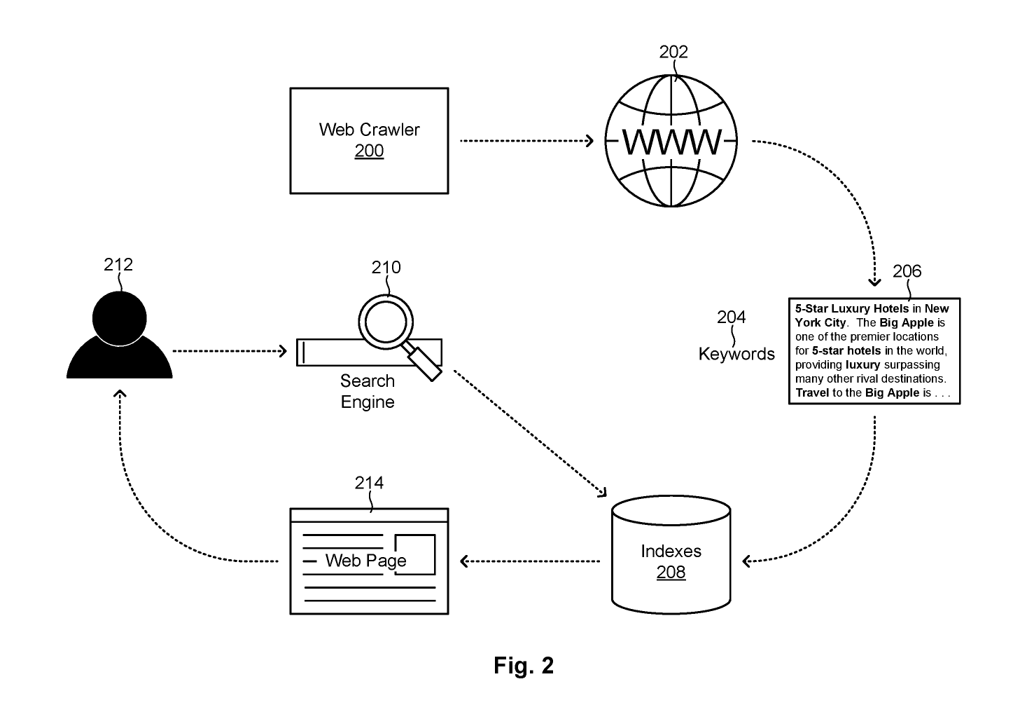

Referring to FIG. 2, as previously mentioned, the Internet provides access to billions of web pages that are organized in the form of websites, portals, and platforms that cover a wide variety of topics. To enable users to find these sites, various companies have developed web crawlers 200 to browse the billions of interconnected documents that make up the world wide web 202. In many cases, the web crawlers 200 look for keywords 204 in the text 206 of web documents or pages, such as in a web page's title, Uniform Resource Locator (URL), body text, image names, meta tags, and/or the like. This information is then used to create indexes 208 that document the information that has been discovered. These indexes 208 may be used by a search engine 210. When a user 212 performs a query using the search engine 210, the user 212 may be presented with links to web pages 214 recorded in the indexes 208. To provide these links, the search engine 210 may need to sift through millions of web pages 214 recorded in the indexes 208 to find matches to a query and rank them in order of relevance and/or popularity.

As was previously mentioned, a key element of a web page 214 is the content that is used by the search engine 210 to generate its indexes 208. This content includes a web page's keywords 204. These keywords 204 may be located or used in a web page's title, Uniform Resource Locator (URL), body text, image names, meta tags, and/or the like. Having a good set of keywords 204 is important to ensure that a web page 214 will appear in the search results related to a certain topic. This will ideally generate more visits to the web page 214 and potentially more business opportunities. Maintaining a good set of relevant keywords 204 can be a daunting and time-consuming task since the information on a website or web page 214 may constantly evolve. Concepts that are presented in many modern-day websites may change or become obsolete at a rapid rate. For example, a website of a news provider may contain news stories that change on an hourly, daily, or weekly basis. Similarly, a website of an online retailer may market products that frequently change.

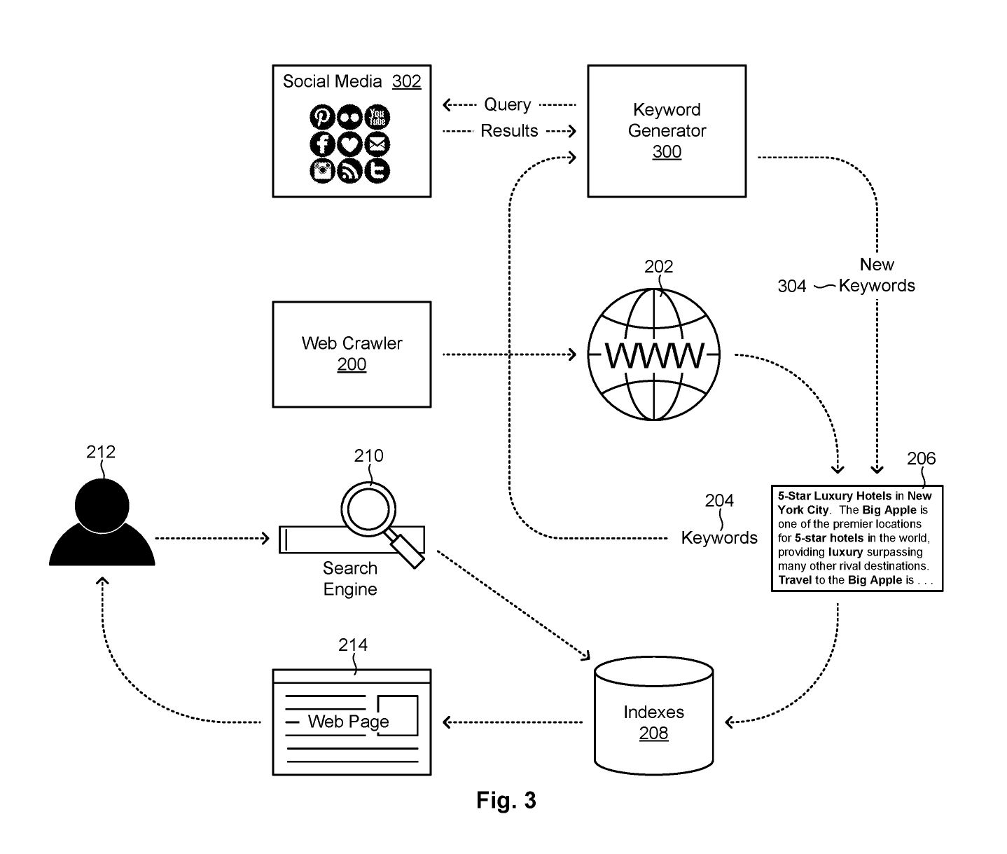

Referring to FIG. 3, in view of the foregoing, systems and methods are needed to ensure that a web page 214 has a good set of keywords 204 to optimize results from search engines 210. Ideally, such systems and methods will frequently update or suggest changes to keywords 204 to keep pace with changes to a web page's content as well changing times and trends, as well as keep pace with comments and ideas that are posted in social networks about topics mentioned in the web page. Thus, systems and methods are needed to leverage social media when determining optimal keywords 204. Such systems and method are disclosed herein.

FIG. 3 shows one embodiment of a keyword generator 300 in accordance with the invention. This keyword generator 300 may be used to update a web page's keywords 204 and/or provide suggestions or information related to a web page's keywords 204. As shown in FIG. 3, the keyword generator 300 may receive an initial or current set of keywords 204 as input and generate a new set of keywords 304 that are ranked based on their relevance. A user may use this new set of keywords 304 to update text 206 or meta tags of the web page 214. In order to generate keywords 304 with increased relevance, the keyword generator 300 may leverage social media platforms 302, such as Pinterest®, Facebook®, YouTube®, Twitter®, Instagram®, Googe+®, and the like, to name just a few. Specifically, the keyword generator 300 may query these social media platforms 302 using an initial or current set of keywords 204 from the web page 214 and, based on the results of the queries, generate a new set of keywords 304 with associated rankings that will ideally have increased relevance to the web page 214. The keyword generator 300 may be implemented as a desktop application, mobile application, web service, thin client accessing a server-side application, or the like.

The keyword generator 300 may be configured to confirm current keywords 204 while also suggesting new keywords 304 that can increase the chances of having a specific web page 214 be included in the results of a search engine 210. As will be explained in more detail hereafter, a novel aspect of the keyword generator 300 is its ability to determine the relevance of a particular keyword 304 based on characteristics of an author of posts or other content retrieved from social media 302, which may have relevance with particular demographics. While existing applications may be able to analyze static information of already existing websites, they are not able to incorporate new keywords 304 based on relevance extracted from dynamic social media content.

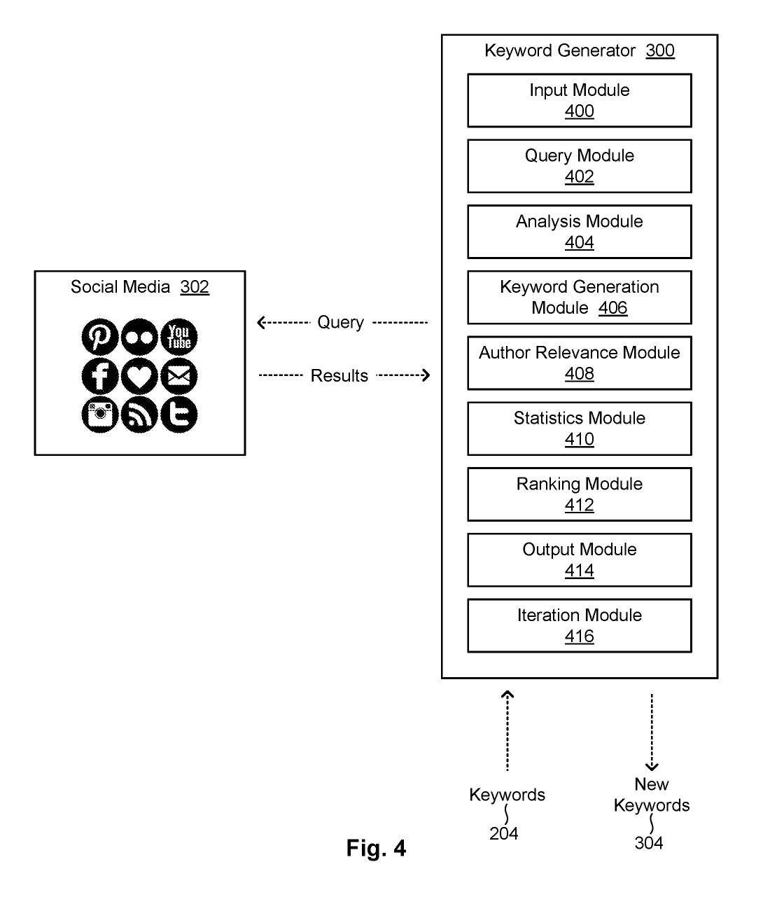

Referring to FIG. 4, the keyword generator 300 introduced in FIG. 3 may include various sub-modules to provide various features and function. As shown, these modules may include one or more of an input module 400, query module 402, analysis module 404, keyword generation module 406, author relevance module 408, statistics module 410, ranking module 412, output module 414, and iteration module 416. These modules and components are presented by way of example and are not intended to represent an exhaustive list of modules or components that may be included within the keyword generator 300. The keyword generator 300 may include more or fewer modules than those illustrated, or the functionality of the modules may be organized differently.

An input module 400 may be used to receive an initial set of keywords 204. These initial keywords 204 may be keywords 204 that are already used within a web page 214, either in the metadata of the web page 214, or in its text or images. Using these initial keywords 204, a query module 402 may query one or more social media platforms 302, such as the platforms previously discussed. These social media platforms 302 may return results to the keyword generator 300 in the form of posts, documents, articles, comments, images, videos, or the like, where the keyword 204 was found. An analysis module 404 may analyze these results and a keyword generation module 406 may generate a new set of keywords 304 (which may include the currently-used keywords as well as new keywords) based on the results. A ranking module 412 determines a ranking or relevance number for each keyword 304 in the new set of keywords 304. To accomplish this, the ranking module 412 may utilize an author relevance module 408 and/or statistics module 410.

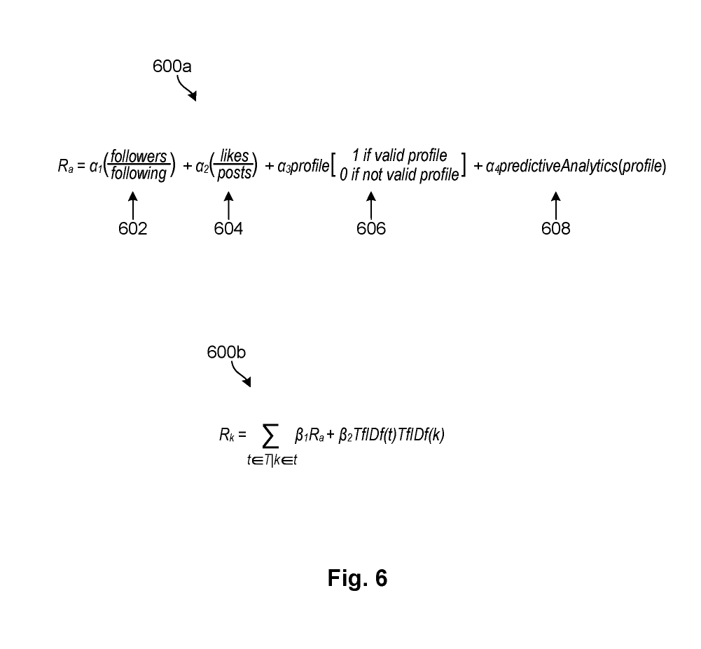

The author relevance module 408 may determine the relevance of an author associated with a post, document, article, comment, image, video that is returned by a social media platform 302. The greater the relevance of the author, the greater impact the author will have on the ranking of a new keyword 304 that has been gleaned from results associated with the author. As will be explained in more detail in association with FIG. 6, the relevance of the author may be calculated based on one or more of an impact of the author, an efficiency of the author, validity of a profile of the author, and predicted influence the author will have in the future. The ability to consider author relevance when ranking a keyword 304 is a novel aspect of the invention that provides, in essence, a crowd-sourced technique for ranking keywords 304.

The statistics module 410 may determine numerical statistics for a new keyword 304, such as the TfIDf (term frequency-inverse document frequency) value, which indicates how important a word is to a document in a collection of documents. This value may be used as a weighting factor when retrieving information or mining text in documents. The TfIDf value increases in proportion to the number of times a word appears in a document, while decreasing in accordance with the frequency the word appears in the collection of documents. This compensates for the fact that some common, non-unique words appear frequently across all documents. Thus, the TfIDf value may represent the uniqueness of a term in addition to the frequency that it is used in a web page 214 or document.

The ranking module 412 uses the author relevance produced by the author relevance module 408 and the numerical statistics generated by the statistics module 410 to produce a ranking for each new keyword 304. An exemplary formula for calculating the ranking will be discussed in association with FIG. 6.

The output module 414 outputs the new set of keywords 304 to a user. The user may then incorporate some or all of the new keywords 304 into a web page 214 to optimize or improve the performance of the web page 214 with search engines. Because the ranked list may include current keywords 204 in addition to new keywords 304, the ranked list may facilitate the comparison of new keywords 304 to current keywords 204 to determine if any new keywords 304 would perform better than the keywords 204 currently being used. If desired, the iteration module 416 may re-input all or part of the new set of keywords 304 into the keyword generator 300 to produce additional and potentially more relevant keywords. The above-described technique for processing keywords 204 is atomic for a set of keywords 204. Thus, the same process may be executed for several web pages 214 in parallel without impacting the expected results for each web page 214.

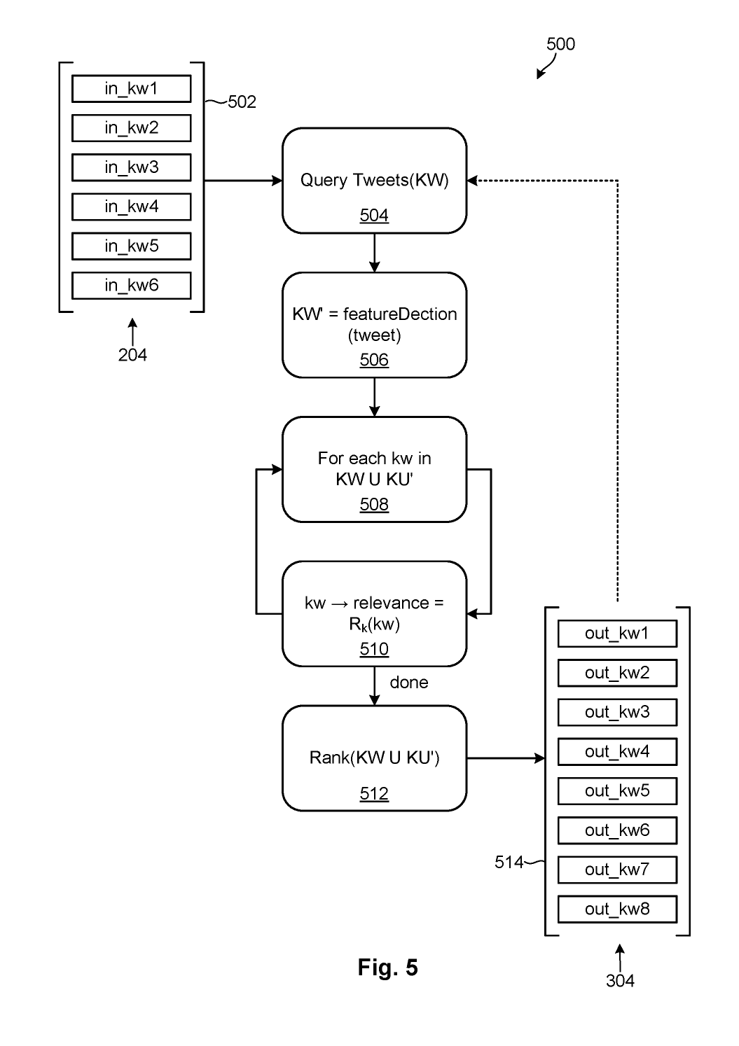

Referring to FIG. 5, one embodiment of a process 500 for generating a new set of keywords 304 from an initial set of keywords 204 is shown. Such a process 500 may be implemented by the keyword generator 300 illustrated in FIGS. 3 and 4. As shown, the process 500 initially receives a set 502 of keywords 204 (KW). The process 500 then queries 504 one or more social media platforms 302 using the keywords 204 (KW) as input. For example, as shown in FIG. 5, the process 500 may query 504 postings (also referred to as “tweets”) on the social media website Twitter®. The process 500 may then analyze 506 the results (e.g., postings), such as by detecting 506 frequently occurring and/or unique text or words in the returned postings, to produce a new set of keywords 304 (KW′). In certain embodiments, the new set of keywords 304 (KW′) are entirely new words. In other embodiments, such as the embodiment illustrated in FIG. 5, the new set of keywords 304 (KW′) is the union of the initial set 502 of keywords 204 along with any new keywords that are discovered in response to the query.

The process 500 then determines the relevance of each keyword (kw) in steps 508, 510. Specifically, for each keyword 204 (kw) in the new set of keywords 304 (i.e., each kw in KW U KW′), the process 500 determines the relevance (Rₖ) of the keyword 304 using the author relevance factors and numerical statistics as will be discussed in more detail in association with FIG. 6. Once the relevance (Rₖ) of each keyword 304 (kw) is determined, the process 500 ranks 512 each keyword 304 in the new set of keywords 304, thereby producing a ranked set 514 of keywords 304. This new set 514 of keywords 304 may, if desired, be re-input to the process 500 in an iterative manner to produce additional keywords.

Referring to FIG. 6, several formulas 600a, 600b for determining an author relevance factor (Rₐ) and keyword ranking (Rₖ) for each new keyword 304 is illustrated. As shown, in one embodiment, the author relevance factor (Rₐ) may be calculated using the formula 600a by adding at least one of the impact 602 of the author, the efficiency 604 of the author, the validity 606 of the profile of the author, and the predicted influence 608 the author will have in the future. Non-limiting examples of how these values 602, 604, 606, 608 may be calculated are provided below. The weight values (α₁, α₂, α₃, α₄) may be adjusted as needed to give more or less weight to the values 602, 604, 606, 608.

In one embodiment, the impact 602 of the author may be calculated by multiplying a first weight value (α₁) by the number of followers of the author divided by the number of individuals/entities that the author is following. Thus, the impact 602 of the author may go up as the number of followers increases (since this may indicate increased influence of the author), and go down in accordance with the number of individuals/entities the author follows (since a high number of follows may indicate that the author gained his or her followers using a “follow back” approach where the author gained followers by promising to follow his or her followers.)

The efficiency 604 of the author may, in certain embodiments, be calculated by multiplying a second weight value (α₂) by the number of “likes” (and/or comments or other indications of approval or interest) of the author's posts, divided by the number of posts (which may include articles, documents, images, comments, etc.) of the author. As the number of posts goes up, the efficiency 604 may go down since the number of “likes” or comments may be spread across more posts and thus result in a lower number of “likes” or comments per post.

The validity 606 of the profile of the author may, in certain embodiments, be calculated by multiplying a third weight value (α₃) by a “1” if the profile of the author is valid (e.g., the author is determined to be a real person) and by a “0” if the profile of the author is invalid (e.g., the author is a “bot” or a non-human entity).

The predicted influence 608 of the author may, in certain embodiments, be calculated by multiplying a fourth weight value (α₄) by the output of a predictive analytic algorithm that will examine a profile of an author and predict how influential the author will be in the future. For example, if the number of followers of an author is increasing or the growth rate of the number of followers of the author is increasing, this may indicate that the author's influence will increase into the future. Similarly, if the number of “likes” or comments to an author's posts is increasing or the growth rate of the number of “likes” or comments to an author's posts is increasing, this may indicate that the author's influence will be increasing in the future. In other cases, the influence of the author may be predicted to decrease, which will in turn reduce the author relevance factor (Rₐ).

The formula 600b may be used to calculate a keyword ranking (Rₖ) for each new keyword 304. As shown, the formula 600b takes a first weight value (β₁) multiplied by the author relevance (Rₐ), and adds it to a second weight value (β₂) multiplied by a TfIDf value for a particular post (t) and a TfIDf value for a particular keyword (k) in the particular post. In essence, the TfIDf value for the particular post (t) represents how relevant the post is compared to all posts (T), and the TfIDf value for the particular keyword (k) represents how relevant the keyword (k) is in the particular post (t) compared to all other words in the post (t). The ranking (Rₖ) of a keyword (k) is calculated by adding the relevance of all authors with posts where the keyword (k) appears plus the TfIDf calculated on the post where the keyword (k) appears multiplied by the TfIDf of the keyword (k) itself.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for determining keyword relevance based on social media, the method comprising:
receiving, by at least one processor, initial keywords associated with a particular web page;
querying, by the at least one processor, at least one social media platform using the initial keywords;
analyzing, by the at least one processor, results of the query and generating new keywords based on the results, wherein analyzing comprises calculating an author relevance factor for each author associated with the results, and generating numerical statistics for occurrences of each new keyword in the results;
determining, by the at least one processor, a ranking for each new keyword based on the author relevance factors and numerical statistics; and
providing the new keywords with associated rankings to a user.

2. The method of claim 1, wherein calculating the author relevance factor comprises increasing the author relevance factor in accordance with a number of followers of the author.

3. The method of claim 2, wherein calculating the author relevance factor comprises decreasing the author relevance factor in accordance with a number of individuals the author is following.

4. The method of claim 1, wherein calculating the author relevance factor comprises increasing the author relevance factor in accordance with a number of likes of the author's posts.

5. The method of claim 4, wherein calculating the author relevance factor comprises decreasing the author relevance factor in accordance with a number of posts of the author.

6. The method of claim 1, wherein calculating the author relevance factor comprises using predictive analytics to determine how relevant the author will be in the future.

7. The method of claim 1, further comprising re-executing the method using the new keywords as inputs to the method.

8. A computer program product for determining keyword relevance based on social media, the computer program product comprising a computer-readable storage medium having computer-usable program code embodied therein, the computer-usable program code comprising:
computer-usable program code to receive initial keywords associated with a particular web page;
computer-usable program code to query at least one social media platform using the initial keywords;
computer-usable program code to analyze results of the query and generate new keywords based on the results, wherein analyzing comprises calculating an author relevance factor for each author associated with the results, and generating numerical statistics for occurrences of each new keyword in the results;
computer-usable program code to determine a ranking for each new keyword based on the author relevance factors and numerical statistics; and
computer-usable program code to provide the new keywords with associated rankings to a user.

9. The computer program product of claim 8, wherein calculating the author relevance factor comprises increasing the author relevance factor in accordance with a number of followers of the author.

10. The computer program product of claim 9, wherein calculating the author relevance factor comprises decreasing the author relevance factor in accordance with a number of individuals the author is following.

11. The computer program product of claim 8, wherein calculating the author relevance factor comprises increasing the author relevance factor in accordance with a number of likes of the author's posts.

12. The computer program product of claim 11, wherein calculating the author relevance factor comprises decreasing the author relevance factor in accordance with a number of posts of the author.

13. The computer program product of claim 8, wherein calculating the author relevance factor comprises using predictive analytics to determine how relevant the author will be in the future.

14. The computer program product of claim 8, further comprising re-executing the method using the new keywords as inputs to the method.

15. A system for determining keyword relevance based on social media, the system comprising:
at least one processor;
at least one memory device coupled to the at least one processor and storing instructions for execution on the at least one processor, the instructions causing the at least one processor to;
receive initial keywords associated with a particular web page;
query at least one social media platform using the initial keywords;
analyze results of the query and generate new keywords based on the results, wherein analyzing comprises calculating an author relevance factor for each author associated with the results, and generating numerical statistics for occurrences of each new keyword in the results;
determine a ranking for each new keyword based on the author relevance factors and numerical statistics; and
provide the new keywords with associated rankings to a user.

16. The system of claim 15, wherein calculating the author relevance factor comprises increasing the author relevance factor in accordance with a number of followers of the author.

17. The system of claim 16, wherein calculating the author relevance factor comprises decreasing the author relevance factor in accordance with a number of individuals the author is following.

18. The system of claim 15, wherein calculating the author relevance factor comprises increasing the author relevance factor in accordance with a number of likes of the author's posts.

19. The system of claim 18, wherein calculating the author relevance factor comprises decreasing the author relevance factor in accordance with a number of posts of the author.

20. The system of claim 15, wherein calculating the author relevance factor comprises using predictive analytics to determine how relevant the author will be in the future.
